(19) United States
(12) Patent Application Publication
(10) Pub. No.: US 2002/0146101 A1
(43) Pub. Date: Oct. 10, 2002

(54) Procedure for preventing overload situations in a telephone network, as well as telephone network, switching centre, control facility and program module for it

(75) Inventors: Hartmut Weik, Stuttgart (DE); Wolfgang Lautenschlager, Weissach (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/101,959

(22) Filed: Mar. 21, 2002

(30) Foreign Application Priority Data
Apr. 10, 2001 (DE) 101 17 954.5

(51) Int. Cl. H04M 15/00

(52) U.S. Cl. 379/112.01

(57) ABSTRACT

The invention concerns a procedure for preventing overload situations in a telephone network which are caused, upon occurrence of an exceptional situation, particularly a disaster or crisis, by increased call attempts by users, in which checking facilities are activated, as a consequence of which only certain connections are then established, call numbers of users (or facilities) of the telephone network or of a sub-network being defined that may make a telephone call during such a situation or that may be dialled as the destination of a telephone call, and a check being performed to determine whether the call number of a calling user or the call number of the user called by this user constitutes one of the respectively defined call numbers and a connection being established between these users only if the result of a said check is positive, as well as a telephone network, switching center, control facility and program module for it.

### BACKGROUND OF THE INVENTION

The invention is based on a priority application DE 10 117 954.5 which is hereby incorporated by reference.

The invention concerns a procedure for preventing overload situations in a telephone network or a sub-network of the telephone network which are caused, upon occurrence of an exceptional situation, particularly a disaster or crisis, by increased call attempts by users, wherein, as consequence,

checking facilities are activated, as a consequence of which only certain connections are then established,

criteria are respectively determined, for the call number of a calling user and the call number of a called user, which permit the establishment of a connection even in an exceptional situation,

a check is performed to determine whether the call number of a calling user and the call number of the user called by this user fulfil the said criteria, and

a connection is established between these users only if the result of the said check is positive, a telephone Telephone network with facilities for preventing overload situations, these facilities comprise the following means:

Memory means for storing criteria for, respectively, the call numbers of calling users and the call numbers of called users,

Checking means for checking the call number of the calling user or the call number of the called user, communicated during a call signalling, to determine whether the said criteria are fulfilled, and

Activation means for activating and deactivating the said checking means, a switching centre, a control facility and a program module to be executed in the control facility.

Public telephone networks, and also private networks, for example, networks for military purposes, are generally dimensioned so that they can manage a certain maximum communication incidence )traffoc öpad). This maximum communication incidence can take account of time-of-day and/or date dependent variations in such a way that foreseeable peak demands can be managed either at any time or for a certain percentage of the time, for example, 95 percent. However, if unforeseeable events occur, for example, the call for telephone participation in a competition from a popular television programme, or upon the outbreak of a natural disaster, the resultant communication demands on the telephone network can rapidly exceed its capacity.

For this, procedures are known in which, following proclamation of an exceptional situation, for example, upon the occurrence of a natural disaster or upon the occurrence of a political crisis, access to the telephone network is restricted from selected (telephone) connections, for example, public telephones, or from selected facilities. All other connections can then serve only as a destination of a telephone call, i.e., calls made from these connections are simply no longer accepted in the telephone network.

Also known, for preventing bottlenecks due to unforeseeable events, is a dynamic procedure in which network nodes which are affected by an overload apply certain restriction procedures. For this purpose, load measurements are performed continuously in certain user-near network nodes or switching centres. If a certain load is exceeded in such a network node due, for example, to mass calling, other, user-remote network nodes which are, or could be, affected by the overload are prompted to reduce this communication traffic by a certain restriction rate.

The first, initially described, procedure of connection-based selection of privileged users has the disadvantage, however, that it can only be applied in the fixed network. Along with the increasing spread of the mobile telephony networks, more and more public telephones are being removed. Moreover, in cases of crises or disaster, it is increasingly mobile facilities or users, in particular, that are privileged or can be reached solely with a mobile telephony terminal. In its concentration exclusively on the fixed network, too, this procedure is unsatisfactory due to its lack of flexibility, since changes to authorized call numbers can only be made in a decentralized manner, for example, through complex configuration changes in local switching centres. Although the second, initially described, procedure offers the advantages of reacting dynamically to the occurrence of an overload, it is nevertheless not possible to give a desired preference to facilities or users that can be dialled in the event of a disaster.

### SUMMARY OF THE INVENTION

The object of the invention is to create a procedure and appropriate means which render possible flexible determination of users, both of a telephone network with fixed connections and of a mobile telephony network, who may make calls or accept calls in the event of a crisis or disaster.

The fundamental concept of the invention is to prevent an imminent overload in a telephone network upon the occurrence of an exceptional situation in that, in such a situation, a system switchover is effected which has the result that only some of all desired connections are established. Defined for this purpose are call numbers of users of the telephone network or of a sub-network who may make a telephone call during such a situation or who may be dialled as the destination of a telephone call. Prior to the establishment of a connection, a check is then performed to determine whether the call number of a calling user or the call number of the user called by this user constitutes one of the respectively defined call numbers. A connection between these users is established only if the said check produces a positive result.

Further advantageous developments of the invention are disclosed by the dependent claims and the description.

The procedure according to the invention and the necessary means are described here with reference to an embodiment in the so-called intelligent network (IN). This embodiment is preferred in this case, since it can be constructed to a large extent on standardized interfaces and protocols, particularly so-called INAP operations, by means of which facilities of the intelligent network communicate with one another. However, the invention can also be realized outside the intelligent network, for example, through appropriate functional expansions of existing digital switching facilities.

Two essential facilities of an intelligent network form the so-called service switching point (SSP) and the so-called service control point (SCP). The service switching point is a digital switching centre which, upon a call made by a user, recognizes the call of a service of the intelligent network, termed IN service in the following, and gives the service control point the possibility of controlling this call.

Whereas the so-called service switching functions of the service switching point are of a decentralized nature and are now generally integrated into each local switching centre, the so-called service control functions of the service control point are of a centralized nature. The service control point of large network operators is thus formed by a number of computers, networked to one another, which communicate with one another via, for example, a powerful so-called local area network (LAN).

The invention is explained further in the following, with reference to the drawing:

### BRIEF DESCRIPTION OF THE DRAWING

FIG. 1 shows an exemplary telephone network according to the invention, with switching centres according to the invention and a control facility, according to the invention, for performing the procedure according to the invention.

FIG. 1 shows a telephone network TN with a first switching centre SSP1, a second switching centre SSP2, a service control point SCP, termed control facility SCP in the following, and a databank DB. The switching centres SSP1, SSP2 represent digital local switching centres with integrated service switching functions. The switching centres SSP1, SSP2 and the databank DB are connected to the control facility SCP, as indicated by the broken lines. A first user TNA is connected to the first switching centre SSP1 of the interconnected switching centres SSP1 and SSP2 via a first line CA and a second user TNB is connected to it via a second line CB. The second switching centre SSP2 is connected to a third user TNC via a third line CC. The connections indicated by broken lines represent signalling connections and the other connections represent payload connections, i.e., connections via which conversation information of the users is carried. Furthermore, there is a demarcated sub-network STN of the telephone network TN, which comprises the second switching centre SSP2.

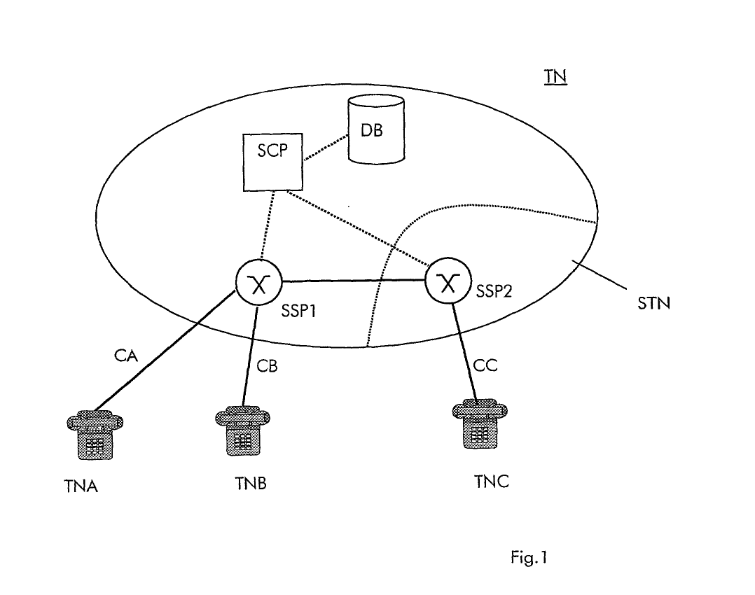

In the following, no distinction is made, in respect of speech, between users and the terminals of users. In addition, a user can also represent a facility, for example, an authority or a hospital.

Firstly, it is to be assumed that the call numbers of the calling user, in the following, for example, the call number of the first caller TNA, represent so-called IN call numbers, i.e., call numbers which can respectively trigger or initiate an IN service in the switching centres SSP1 and SSP2. In normal times, the facilities according to the invention for preventing overload situations remain passive. In the event of a disaster, these facilities are activated through, for example, manual input into a central network management facility. All switching centres SSP1 and SSP2 of the telephone network TN or the switching centres of an area affected by the disaster or of the sub-network STN are informed of the presence of the disaster. From that time onwards, these switching centres SSP1 and SSP2 do not effect the establishment of any further connections for incoming calls without an authorization check first being performed.

In a first variant, only the authorization of calling users or the authorization to call from a particular terminal is checked. For example, if the first user TNA then calls the second user TNB, the first switching centre SSP1, to which the first user TNA is connected, passes the call number of the first user TNA, which is communicated with the call signalling, to the control facility SCP. The control facility SCP consults the databank DB to verify whether the user TNA of this call number has a calling authorization. This databank DB contains a list with all call numbers of authorized users. If the result of the check is positive, i.e., if the call number is found in the list of authorized users, the control facility SCP instructs the first switching centre SSP1 to establish the desired connection to the second user TNB. If the result of the check is negative, the control facility SCP instructs the first switching centre SSP1 to break its connection to the first user TNA. Facilities from which calls may be made in the event of a disaster can be, for example, all public facilities or selected public facilities such as hospitals, fire stations, disaster centres, etc., and public telephones. In addition, certain users, for example, doctors, police, etc. can be selected.

In a second variant, authorization is checked only in respect of whether a certain user or a certain facility may be called. For example, if the first user TNA calls the second user TNB, the first switching centre SSP1, to which the first user TNA is connected, passes the call number of the called second user TNB, which is communicated with the call signalling, to the control facility SCP. Similarly to the first variant, the control facility SCP checks whether the user TNB of this call number has an authorization. If the result of the check is positive, i.e., if the call number is found in the list of authorized users, the control facility SCP instructs the first switching centre SSP1 to establish the desired connection to the second user TNB. If the result of the check is negative, the control facility SCP instructs the first switching centre SSP1 to break its connection to the first user TNA. Selected facilities or users that may be called can be the facilities mentioned in connection with the first variant. For the purpose of accelerated checking, provision can also be made whereby emergency numbers, for example, in Germany, the call numbers 110 and 112, are recognized directly in the switching centres SSP1 and SSP2, without being indirectly routed via the control facility SCP, and the respective connections can thus be established without delay. The first and second variants have the disadvantage that the authorization check is effected either in respect of the caller only or in respect of the called party only. However, it can be very advantageous if, on the one hand, an unrestricted active calling authority is granted only to a small group of users, and all other users are granted a calling authority to selected destinations only.

For this purpose, in a preferred third variant, the checks described in the preceding variants are combined. For this, a check is first performed to determine whether a calling user has an active calling authority. If no active calling authority exists, a check is performed in the subsequent step to determine whether the call destination may be called. The desired connection is rejected only if both checks prove negative. If, for example, the first user TNA calls the second user TNB, the first switching centre SSP1, to which the first user TNA is connected, passes the call numbers of both the calling first user TNA and the called second user TNB, which are communicated with the call signalling, to the control facility SCP. In exactly the same manner as in the first variant, the control facility SCP checks whether the user TNA of this call number has a calling authorization. If the result of the check is positive, i.e., if the call number is found in the list of authorized active users, the control facility SCP instructs the first switching centre SSP1 to establish the connection to the second user TNB. If the result of the check is negative, the control facility SCP checks whether the call number of the called user TNB is contained in a second list of call numbers of authorized passive users. If the result of the check is positive, the control facility SCP likewise instructs the first switching centre SSP1 to establish the desired connection to the second user TNB. If the result of the check is negative, the control facility SCP instructs the first switching centre SSP1 to break its connection to the first user TNA.

To reduce the load on the (central) control facility SCP, the checks can be performed, wholly or partially, directly in the switching centres SSP1 and SSP2. A two-stage checking of the calling authorization is particularly advantageous. Thus, for example, in the case of a call from the first user TNA, a check is performed in the first switching centre SSP1, in a first stage, to determine whether the call number of this user TNA is contained in a locally stored call number list. If the result of the check is positive, the desired connection is then established immediately. Only in the case of a negative check result is the control facility SCP consulted; it then continues the checking procedure, in a second stage, according to the first or third variants. Similarly, in addition to or instead of this, a procedure for checking the called call numbers can be used. Furthermore, it is also possible for only one check to be performed in a second stage if the respective switching centre SSP1 or the control facility SCP is not overloaded. In the event of overload, if the result of the check is negative, the connection is then broken immediately in the first stage.

A check in two stages is also advantageous if only a local area or sub-network STN is affected by an exceptional situation. In this case, in the case of a call from, for example, a first user TNA, a first check is performed in the switching centre SSP1 to determine whether the destination call number leads into the sub-network STN. If the destination call number represents a call number of the second user TNB, located outside the sub-network STN, the desired connection is established without further checking. If the destination call number represents a call number of the third user TNC, located within the sub-network STN, a second check is performed in the control facility SCP. For this first check, only a part of the call number of the called user, for example, the area prefix, need be resolved. For the second check, the rest of this call number and/or the call number of the calling user TNA is resolved.

One of the IN services offered in the intelligent network concerns a time-dependent destination control; i.e., a user who has set up such a service can be reached in dependence on time, under a unified call number, at different defined connections. In the checking of the passive calling authorization, the procedure relating to this IN service can be linked to one of the described procedures of the preceding variants. For this purpose, for example, the unified call number of the second user is contained in the second list of call numbers of authorized passive users, as mentioned in the second and third variants, with a passive calling authorization. If this call number is called in the event of a disaster, the control facility SCP resolves this call number into a corresponding physical call number and communicates this call number to the first switching centre SSP1 for the establishment of a connection to this second user TNB.

It has hitherto been assumed that the call numbers of the calling users represent IN call numbers. It is also possible, in a further embodiment, for it to be a condition only that users with an active calling authorization have an IN call number. Since a check of the active calling authorization can only be performed for IN call numbers, in the case of an exclusive solution by means of facilities and procedures of the intelligent network, all connection requests from users of other call numbers are rejected without checking. It is also possible, however, to perform the checking of the said first stage within the switching centre by means of proprietary functions. Connections could thus also be established to selected users without IN call numbers.

The facilities, according to the invention, for preventing overload situations can also be activated automatically, instead of manually. For this, load measurements can be performed, in the switching centres, which are evaluated in a control facility. If these load measurements result in, for example, a dramatic increase in calls in a certain region or certain sub-network, the said facilities are automatically activated.

In a further variant, different user lists are set up for different types of crises or disasters. Thus, in the event of a natural disaster, it may be expedient to privilege users other than those privileged in a political crisis situation.

The described procedures can be realized both in the fixed network and in mobile telephony networks, for example, in the GSM network or other cellular mobile telephony networks.

1. Procedure for preventing overload situations in a telephone network or a sub-network of the telephone network which are caused, upon occurrence of an exceptional situation, particularly a disaster or crisis, by increased call attempts by users, wherein, as consequence,
checking facilities are activated, as a consequence of which only certain connections are then established,
wherein
criteria are respectively determined, for the call number of a calling user and the call number of a called user, which permit the establishment of a connection even in an exceptional situation,
a check is performed to determine whether the call number of a calling user and the call number of the user called by this user fulfil the said criteria, and
a connection is established between these users only if the result of the said check is positive.

2. Procedure according to claim 1, wherein, for the purpose of defining the criteria, call numbers of users who may make a telephone call or call numbers of users who may be dialled as the destination of a telephone call are determined.

3. Procedure according to claim 1, wherein the checking is performed in two stages, the checking firstly being performed in a local switching centre, in a first stage, and a second checking being performed in a central control facility only in the event of a negative check result.

4. Procedure according to claim 1, wherein, for different types of exceptional situation, different groups of users are defined whose call numbers may respectively be sources and/or destinations of telephone calls.

5. Procedure according to claim 1, wherein the activation is effected through manual input.

6. Procedure according to claim 1, wherein the activation is effected automatically if certain load parameters are exceeded.

7. Telephone network with facilities for preventing overload situations, wherein these facilities comprise the following means:
Memory means for storing criteria for, respectively, the call numbers of calling users and the call numbers of called users,
Checking means for checking the call number of the calling user or the call number of the called user, communicated during a call signalling, to determine whether the said criteria are fulfilled, and
Activation means for activating and deactivating the said checking means.

8. Switching centre for a telephone network, with:
Transmission means for communicating to a control facility the call number of the calling user or the call number of the called user, communicated during a call signalling,
Receiving means for receiving a further-processing instruction from a control facility, with the information, whether the respective connection is to be established or whether the call is to be terminated, and
Execution means for executing the further-processing instruction.

9. Control facility for a telephone network, with:
Receiving means for receiving the call number of a calling user or the call number of a called user from a switching centre,
Checking means for checking the call number of the calling or the called user to determine whether one of these call numbers fulfils criteria which permit the establishment of a connection in an exceptional situation, and
Transmission means for communicating a further-processing instruction to the switching centre, with the information, whether the respective connection is to be established or whether the call is to be terminated.

10. Program module for execution in a control facility for a telephone network, with means for controlling the following steps:
Receipt of the call number of a calling user or the call number of a called user from a control facility,
Checking of the call number of the calling or called user to determine whether one of these call numbers fulfils criteria which permit the establishment of a connection in an exceptional situation, and
Determination of a further-processing instruction, with the information, whether the respective connection is to be established or whether the call is to be terminated.
